(19) United States
(12) Patent Application Publication
(10) Pub. No.: US 2008/0037434 A1
(43) Pub. Date: Feb. 14, 2008

(54) Modeling of residue errors using models that adapt on the basis of link quality indicators

(75) Inventors: Hayder Radha, East Lansing, MI (US); Shirish S. Karande, Lansing, MI (US); Utpal Parrikar, San Diego, CA (US); Kiran Misra, Lansing, MI (US)

Correspondence Address: HARNESS, DICKEY & PIERCE, P.L.C., P.O. BOX 828, BLOOMFIELD HILLS, MI, 48303, US

(73) Assignee: Board of Trustees of Michigan State University, East Lansing, MI (US)

(21) Appl. No.: 11/725,243

(22) Filed: Mar. 16, 2007

Related U.S. Application Data
(60) Provisional application No. 60/784,109, filed on Mar. 17, 2006.

(51) Int. Cl. G06F 11/00

(52) U.S. Cl. 370/244; 370/252

(57) ABSTRACT

A method is provided for adapting models on the basis of link quality indicators. A plurality of statistical models which predict whether a given data bit in a stream of data bits is in error are first defined, where each model includes an indicator of bit errors in the bit stream used to train the model. The method then includes: receiving a data packet at a receiver in a wireless network; determining an indicator of bit errors for the received data packet; and processing the data packet at the receiver using a model from the plurality of models which correlates to the bit error indicator for the data packet.

### CROSS-REFERENCE TO RELATED APPLICATIONS

This application claims the benefit of U.S. Provisional Application No. 60/784,109 filed on Mar. 17, 2006. The disclosure of the above application is incorporated herein by reference.

### FIELD

The present disclosure relates generally to adapting model on the basis of link quality indicators.

### BACKGROUND

Recent years have seen an increased deployment of 802.11b based wireless LANs (WLAN) in, home and office setups. Concurrent with this trend has been an increased demand for multimedia applications. The above two synergistic growths have in turn led to an increased demand for seamless availability of multimedia content over wireless media. However, often in practical deployments of 802.11b WLANs, it has been observed that the number of packet drops due to bit corruption of the MAC frames can be significant. This decrease in throughput can adversely affect the performance of network applications and especially multimedia applications over the wireless network. As a result, some of the recent studies have advocated a cross-layer error-control strategy that can recover data even from the corrupted packets and improve throughput.

Utility/feasibility of data recovery from corrupted MAC frames is a function of the “residue error” patterns observed at the link-level. Here, residue error represents bit errors that are not corrected by the physical layer, and consequently they appear within (corrupted) packets at the link-layer and possibly at other higher layers. In this document we analyze and model the behavior of the actual residue error patterns observed at the 802.11b link-level based on crucial parameters and side information that can be collected at the physical layer. The proposed work thus has important implications for design of future error control protocol and deduction of performance bounds.

Previous attempts at modeling 802.11b (WLAN) residual errors have typically not taken into consideration packet boundaries and attempt to characterize the entire residue error traces on the basis of a single set of model parameters. In addition, previous modeling techniques employed at the link-level do not incorporate any channel state information (CSI) that can be associated with a residue error trace during the data collection step of the experimentation. In this work, we show that modeling techniques such as the above are inherently attempting to model a non-stationary process and thus can often lead to conclusions that are not broadly applicable. In particular, we show that the observations about long-range dependence of the residue error process can vary from one experimental setup to another.

The behavior of a residue error process and in fact the wireless channel can be influenced by many factors, such as presence of interfering sources, receiver mobility and terrain (which in the context of the home/office setup considered in this document corresponds to presence of walls etc). It's natural to expect the behavior of the error process to vary from one environment to another and correspondingly also with time if the surroundings are even slightly dynamic. Thus it is hard to characterize the channel behavior in a manner that would be independent of the above mentioned environmental/infrastructural biases. Signal to Silence Ratios (SSR) can be used as a representation of the overall Signal to Interference/Noise Ratio and thus the error process when “conditioned” on a SSR can be expected to behave similarly across different environments. Thus the SSR indications, that typical 802.11b radio hardware is capable of providing, can be used very practically for link-layer model adaptation. Nonetheless, other indicators as to the errors contained in a given data packet are also contemplated by this disclosure.

When expressed as a function of SSR, the average bit error rate in a corrupted MAC frame indeed has a constant relationship across different environments. The invariance of this first-order relationship is essential for invariance in higher order relationships to exist. Invariance in higher order relationships is essential for a single Markov model associated with a particular SSR to characterize all residue errors in packets with that particular SSR. Thus the above result is used as a motivation for the remainder of the work. We also quantify, on the basis of mutual information, the variations in the temporal correlation of the residue error process with respect to the SSR range. It is observed that the amount of temporal correlation can vary as a function of SSR, thus providing further motivation for the proposed work.

The statements in this section merely provide background information related to the present disclosure and may not constitute prior art.

### SUMMARY

A method is provided for adapting models on the basis of link quality indicators. A plurality of statistical models which predict whether a given data bit in a stream of data bits is in error are first defined, where each model includes an indicator of bit errors in the bit stream used to train the model. The method then includes: receiving a data packet at a receiver in a wireless network; determining an indicator of bit errors for the received data packet; and processing the data packet at the receiver using a model from the plurality of models which correlates to the bit error indicator for the data packet.

Further areas of applicability will become apparent from the description provided herein. It should be understood that the description and specific examples are intended for purposes of illustration only and are not intended to limit the scope of the present disclosure.

### DRAWINGS

FIG. 1 illustrates a method for adapting models on the basis of link quality indicators;

FIGS. 2 and 3 illustrate an experimental setup for collecting 801.11b frames in various environments;

FIG. 4 is a graph depicting a variance of the number of bit errors per packet as function of aggregation scales;

FIG. 5 is a graph depicting probability of receiving an uncorrupted packet;

FIG. 6 is a graph depicting probability of bit errors in relation of a signal to noise ration for the corrupted packets;

FIG. 7 is a graph depicting normalized mutual information between bits in corrupted packets;

FIG. 8 is a graph depicting conditional entropy for varied order models as a function of signal to silence ratio;

FIGS. 9A and 9B are graphs depicting experimental test data derived in a home environment;

FIGS. 10A and 10B are graphs depicting experimental test data derived in a office environment; and

FIG. 11 is a graph depicting variance of number of bit errors per packet as function of different aggregation scales.

The drawings described herein are for illustration purposes only and are not intended to limit the scope of the present disclosure in any way.

### DETAILED DESCRIPTION

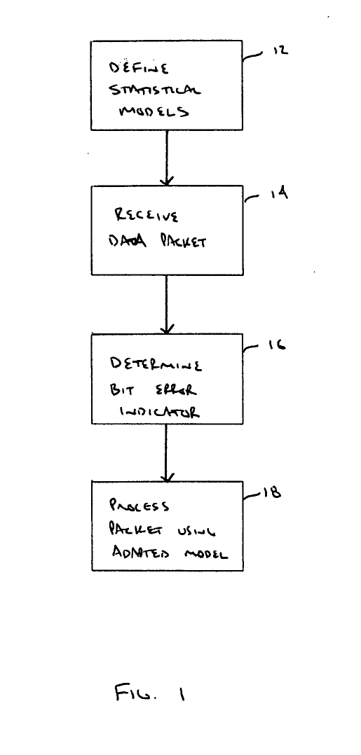

An improved technique is provided for processing data packets at a receiver in a wireless network as shown in FIG. 1. Briefly, a plurality of statistical models is defined at 12 for different transmission environments. Each model predicts whether a given data bit in a bit stream is in error and includes an indicator as to the number of bit errors in the bit stream used to train the model. In an exemplary embodiment, Markov models are used to predict errors in a bit stream as will be further described below.

Upon receiving a data packet 14 at a receiver, an indicator of the bit errors contained therein is determined 16 for the data packet. The data packet in then processed at 18 using the model which correlates to the bit error indicator for the data packet. For subsequent data packets, the statistical model is further adapted using the applicable bit error indicator for the data packet.

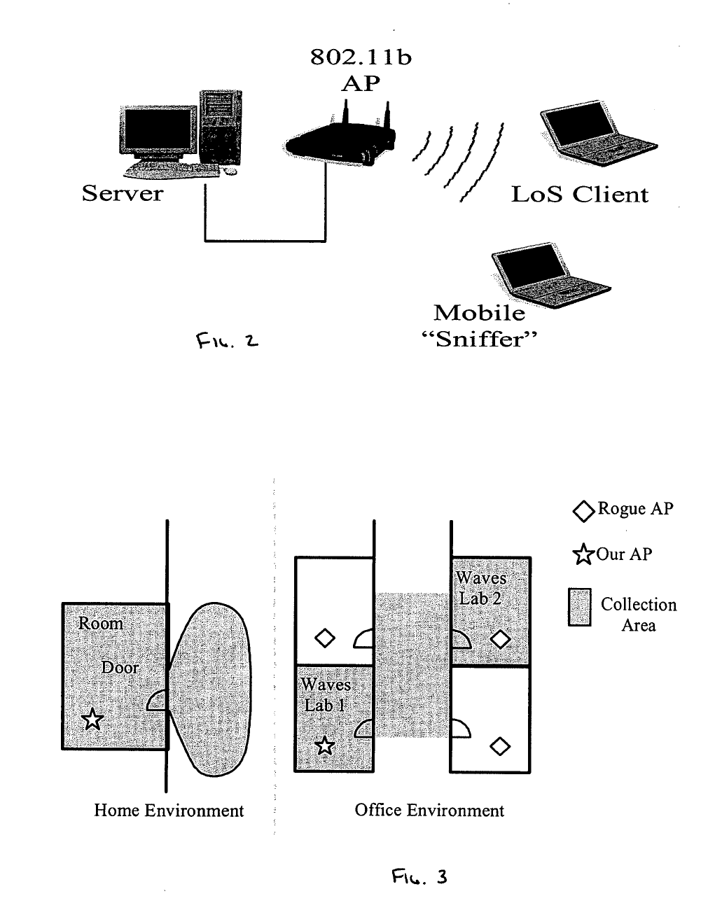

FIGS. 2 and 3 illustrate an experimental setup for collecting 801.11b frames in various environments. The setup consisted of 802.11b access point (AP) operating in distributed coordination function mode with RF output power set at 18 dBm. A station is connected to the AP using 100 Mbps Ethernet and acts like a server, while a wireless station serves as a line of sight (LoS) client. A third wireless station serves as “sniffer” machine. A DWL 122 wireless card based on Prism 2.5 chipset was used for all “sniffer” machines to avoid any fluctuations due to receiver sensitivity. The Prism based card enables operation in “monitor” mode which enables delivery of all the MAC frames without any filtering, including those with failed Frame Check Sequence (FCS).

For the trace collection, the AP transmits packets over the wireless medium to the LoS client at 11 Mbps and the “sniffer” sniffs these transmissions from various locations with different link quality. The source code of the “sniffer” device driver was modified to dump all the corrupted/uncorrupted frames from the kernel buffer space. The Prism 2.5 device also measures received signal strength indication (RSSI) value and “silence” value at the antenna of the radio hardware. The RSSI is measured for 10 μs while receiving the frame and provides total power observed, including signal, interference and background noise. The “silence” value measures total power before the start of the frame. Both these values are collected per-frame basis and reported as Signal-to-Silence ratio of that particular frame. In this document all references to Signal-to-Noise Ratio (SNR) also imply the RSSI to silence value ratio. Packets that correspond to the LoS Client were recovered from the packet dump at a later stage and the XOR images of the LoS Client and the sniffer are used as error traces.

The work environments where traces were collected have been broadly classified into two groups as shown in FIG. 3. The first setup (referred to herein as Home Setup) consisted of a relatively interference-free Home environment. The second setup (referred to herein as Office Setup) consisted of an office environment with 2 to 3 “Rogue” (i.e. interfering) APs on a single channel. In this study we only consider the 802.11 PHY bitrate of 11 Mbps. We collected about 1.5 million packets in Home Setup at a packet transmission rate of 384 packets/sec and another set of 1.5 million packets in Office Setup at a packet transmission rate of almost 1000 packets/sec. For both the Office and Home setup, the A.P and the sniffer had at least one wall between them. The size of the rooms in which the data was collected, varied approximately from a 10 by 10 feet room in a house to a 30 by 30 feet office space. The sniffer machine was not necessarily static; the mobility was completely determined by the arbitrary slow/occasional movement of a human subject collecting the traces.

Let {zᵢ} be a random process defined on the error trace, such that zᵢ represents the total number of packet errors in the i^{th} data packet. The data process {zᵢ} can be aggregated at a scale m by defining a random process

$${z}_{i}^{( m )} = {\sum }_{j = ( i - 1 ) \cdot m + 1}^{i \cdot m} {z}_{j}$$

such that, the sequence length of {zᵢ^{(m)}} is 1/m time's length of {zᵢ}).

The variance of zᵢ^{(m)}, derived from the actual wireless trace data can be used to deduce whether the process {zᵢ} is long range dependent. On the basis of the slope of the curve defining the relationship between log₂ (var(z^{(m)})) and log₂ (m) it had been deduced that the process {zᵢ} is long range dependent. We conduct a similar analysis, with the traces collected in this work.

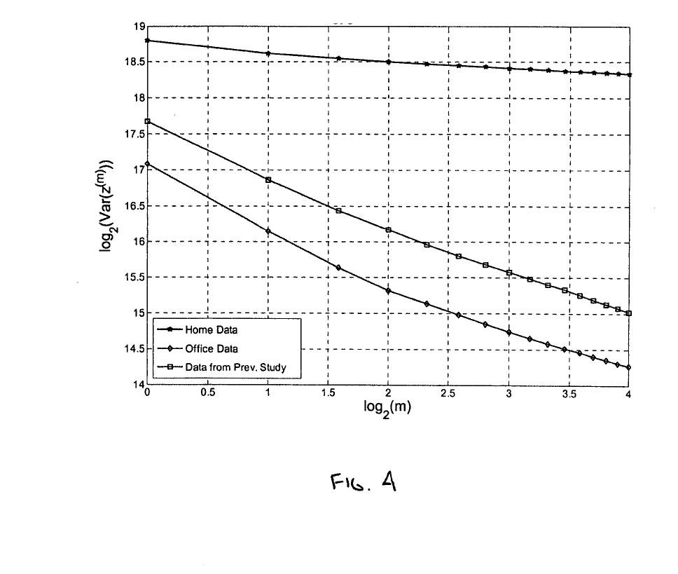

FIG. 4 shows the log-variance plots for the Home and Office data. It can be observed that the slope of the plot varies, depending on the environment in which the traces were collected. A process is long range dependent if the Hurst parameter lies between 0.5 and 1. From the FIG. 3 it can be deduced that H=0.9375 corresponds to the Home_Data and H=0.3125 corresponds to the Office_Data. Thus based on the observation in one wireless infrastructure one might conclude that {zᵢ} is long range dependent and based on another infrastructure we could get a completely different conclusion. Hence, unless the radio-link parameters are taken into account, a model may be ignoring the fact that the “source/cause” for the residue errors has been altered and thus the process is non-stationary.

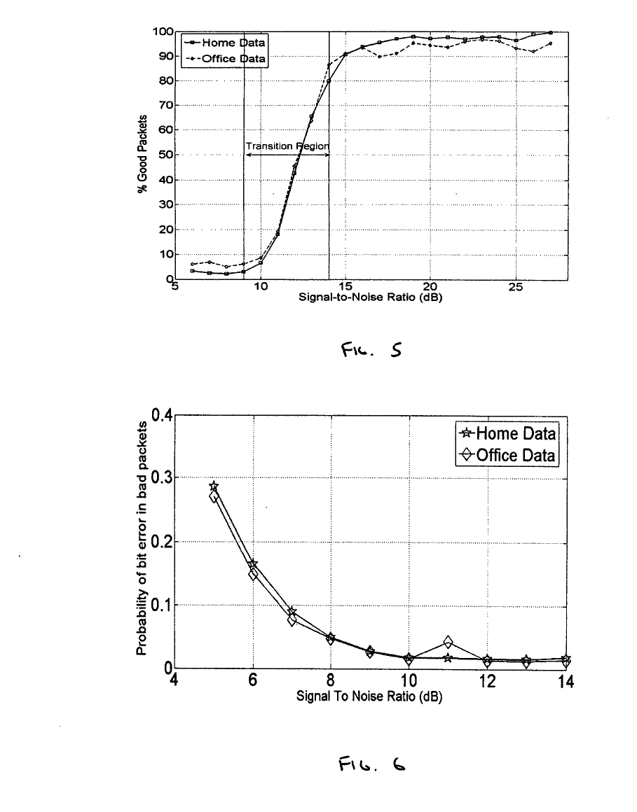

FIG. 5 shows the probability of receiving a completely uncorrupted packet at a particular SSR. The SSR values 0-7 dB, 7-14 dB and 14 db-above form the SSR ranges bad, transition and good, respectively. The probability of receiving an uncorrupted packet varies as 0-0.1 in the “Bad Range”, 0.1-0.9 transition range and 0.9-1.0 in the “Good Range”. For SSR values above 14 dB, corrupted packets are rare and thus the confidence in the relationships presented for this range is low. Explicit attempts at collecting large quantities of bad packets in the “Good Range” haven't been made due to lack of utility of data recovery from corrupted packets in extremely good channel conditions. Also note that corrupted packets are referred to herein as “Bad Packets” and uncorrupted packets are referred to as “Good Packets”.

Next, the relationship of SSR and the average bit error rate in a corrupted packet received with the corresponding SSR indication is evaluated. The value of ε̅(̅S̅N̅R̅)̅ was obtained by measuring the average percentage of corrupted bits in all corrupted MAC frames for a given SSR value. FIG. 6 shows the plots based on such an evaluation. It can be observed that the distribution for Home_Data fits Office_Data pretty well. Thus if SSR is taken into consideration, a single model can be expected to represent at least the first order statistic of residue errors over different environments.

To quantify the amount of memory in the residue errors of corrupted packets, the sample mutual information is calculated as a function of lag_{η}. The sample mutual information can be calculated by considering the sequence of errors in a packet {xᵢ} and then evaluating the mean frequency f{xᵢ,x_{i+η}} of each possible combination of {xᵢ,x_{i+η}}. The frequency f(xᵢ) is nothing but the average probability of error ε̅. Thus the mutual information is then calculated using the standard mutual information formula

$$I ( η ) = \sum f ( {x}_{i} , {x}_{i + η} ) {log}_{2} ( \frac{f ( {x}_{i} , {x}_{i + η} )}{f ( {x}_{i} ) \cdot f ( {x}_{i + η} )} )$$

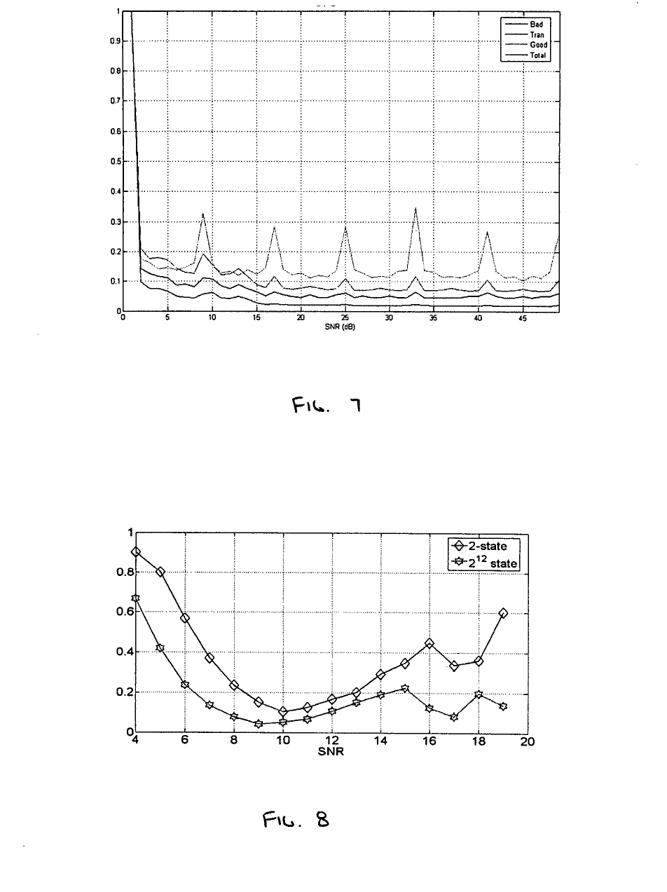

FIG. 7 shows the SSR range wise mutual information normalized by the sample entropy

$$H ( {X}_{i} ) = \sum f ( {x}_{i} ) {log}_{2} ( \frac{1}{f ( {x}_{i} )} ) .$$

It can be seen that the mutual information decays faster as function of lag when the SSR values are low. As the SSR values increase, the memory increases. Thus, naturally implying the need for different models at different SSR ranges.

Ideally, the length of the channel model should be varied as a function of SSR. However in order to simplify the analysis and make a more fluent presentation in this document we focus on models that have equal memory length for all SSR values. Thus unlike a traditional approach of modeling, where the memory length of a process is identified before choosing a model, we choose a specific model order and then try to evaluate the utility of the model. The utility of the model should thus be expected to vary as a function of SSR.

In an exemplary embodiment, a Markov model is used to model the bit patterns. A full state Markov model is defined by a set of state transition probabilities: p(Sᵢ|Sⱼ) for every i, j, where Sᵢ and Sⱼ are the different states. In this work, the states are defined by bit patterns: [x₁, x₂, L, xₖ]. Thus a bit string of length k leads to 2^{k} states. Thus a bit sequence can be converted into a sequence of states. An example is further described below. Let's say we have four states, S_{0,0}, S_{0,1}, S_{1,0}, S₁₁. Thus the following bit-string: 0010110101 can be represented by the following state sequence (by shifting 1 bit at a time) S₀₀S₀₁S₁₀S₀₁S₁₁S₁₀S₀₁S₁₀S₀₁. From state sequence such as the one given above, we can empirically calculate the state transition probabilities e.g. lets say we want to calculate p(S₁₀|S₀₁). Ignoring, the state at the left boundary, the state S₀₁ occurs in the sequence 3 times. Of these 3 occurrences, S₀₁ is followed by state S₁₀ twice. Thus we can empirically evaluate p(S₁₀|S₀₁)=⅔. We also define probabilities:

$$π ( {S}_{i} ) = {\sum }_{j} p ( {S}_{i} \vert {S}_{j} )$$

which represent the probability of occurrence of a specific state. In the above example
π(S₀₁)= 4/9, π(S₀₀)= 1/9, π(S₁₁)= 1/9, π(S₁₀)= 4/9

For a memory length k, the bit errors x̅=[x₁, x₂ . . . xₖ] have 2^{k} possible error patterns. The states of the Markov model we employ here are described by the bit error pattern of the previous k bits. Since we formulate a distinct state for each possible error pattern, the Markov model used in this document can be referred to as a full-state Markov (FSM) chain. The Markov chain we employ is auto-regressive in nature, such that for each state transition [x₁, x₂ . . . xₖ]→[x₂, . . . xₖ, xₖ₊₁], the output is a single error bit xₖ₊₁. Thus the state transition probabilities provide us with the probability of error at a particular bit location, conditioned on the error pattern of the previous k bit locations. Such a modeling approach is particularly useful in practical setups. While the following description is provided with reference to Markov models, it is readily understood that other types of statistical models, such as Hidden Markow models, hierarchical Markov models or multifractal models, are contemplated by this disclosure.

Let us say that that the training data that we have can be classified into different categories. Let the data be classified into two categories which are labeled as Z=1 and Z=0, where the class of data labeled as Z=1 can be further sub-categorized depending on the SSR associated with the packets. Thus associate a label (Z,SSR) with each subclass. A distinct Markov model is trained for each class to get a PA FSM and the following set of conditional state-transition probabilities: p(Sᵢ|Sⱼ,Z)=p([x₂, x₃, L, xₖ₊₁]|[x₁, x₂, L, xₖ], Z) or we train a distinct FSM for each sub-class to get a SAPA FSM and the following set of conditional state-transition probabilities:
p(Sᵢ|Sⱼ,Z,SSR)=p([x₂,x₃,L,xₖ₊₁,]|[x₁,x₂,L,xₖ],Z,SSR).

Two exemplary models are further considered below. Both models are obtained by evaluating the transition probabilities only over the corrupted packets. Let z be an indicator random variable (obtained from the Frame Check Sequence) that can indicate whether a packet is corrupted (Z=1) or uncorrupted (Z=0). Thus, an SSR_Unaware model is obtained by evaluating the transition probability p([x₂, . . . xₖ, xₖ₊₁]/([x₁, x₂ . . . xₖ], Z=1) for each possible pattern; whereas, a SSR_aware model is obtained by evaluating the transition probability p([x₂, . . . xₖ, xₖ₊₁]/([x₁, x₂ . . . xₖ], Z=1, SSR) for each possible pattern.

With reference to FIG. 8, the conditional entropy can be calculated as

$$H ( {X}_{k + 1} / SSR = c , [ {X}_{i} , … {X}_{k} ] ) = - {\sum }_{SRN = y} ( \begin{matrix}f ( {x}_{k + 1} / SSR = c , [ {x}_{i} , … {x}_{k} ] ) \cdot \\ {log}_{2} ( f ( {x}_{k + 1} / SSR = c , [ {x}_{i} , … {x}_{k} ] ) )\end{matrix} )$$

Thus the conditional entropy measures the uncertainty associated with the error process if the SSR value is known and the previous k values are known. It can be seen that increasing the memory length of the model is beneficial at all SSR values, however at very low SSR values the entropy of the error process may be too high to provide any useful information even when a high order Markov model is used. As against that in a transition region the benefits of increasing the order of the model starts diminishing as the size of the order starts equaling the memory length of the process. For high SSR values, increased memory can provide significant performance benefits. Thus it can be clearly observed that different strategies may have to be adopted to model residue error processes in different SSR ranges.

The performance of the full-state Markov chains (FSM) is measured in terms of the ability of the synthesized data to replicate the features of the actual error process. The features are defined in terms of random variables such as inter-arrival rate I and the frequency of errors per packet p. The performance of the model is quantified in terms of Entropy Normalized Kullback-Leibler Divergence between the probability distributions of the various random variables. Further details regarding this technique may be found in S. A. Khayam and H. Radha, “Markov-based Modeling of Wireless Local Area Networks,” ACM MSWiM, September 2003 which is incorporated herein by reference.

The Kullback-Leibler distance gives approximately the difference in bits required to code a single symbol for the two probability distributions. If the probability distributions are close to each other the distance should be close to zero. However the Kullback-Leibler distance does not portray the complete picture, e.g., a distance of 1 bit represents a smaller distance from the original distribution if the number of bits required to represent a symbol is 10 compared to case when the original distribution required 1 bit. The measure can be improved by normalizing the Kullback-Leibler distance with entropy. Thus the expression for ENK is given by

$$ENK ( p ( \overline{X} ) \vert \vert q ( \overline{X} ) ) = \frac{D ( p ( \overline{X} ) \vert \vert q ( \overline{X} ) )}{H ( p ( \overline{X} ) )}$$

where p( X̅) is obtained from the actual trace data and q( X̅) is obtained from the synthesized data.

The training set for the Markov models was formed by randomly choosing 70% of the corrupted packets from the Home_Data. The remaining 30% was used as test data. The transition probabilities for the Markov models were determined based on this training data. Once the training was done, the transition matrix was used to synthesize the data. To synthesize data, choose the first state according to the distribution π(Sᵢ). Choose the next state in accordance to the first choice. So let say we choose the first state to be S₀₁, then choose the next state according to the distribution p(Sᵢ|S₀₁). The state sequence obtained in the above manner can now be converted into a bit-sequence. The relative entropy of the synthesized data with the test data was compared with the relative entropy of the training data with the test data. This allows us to compare the performance of the model vis-à-vis the ability of the source to model itself.

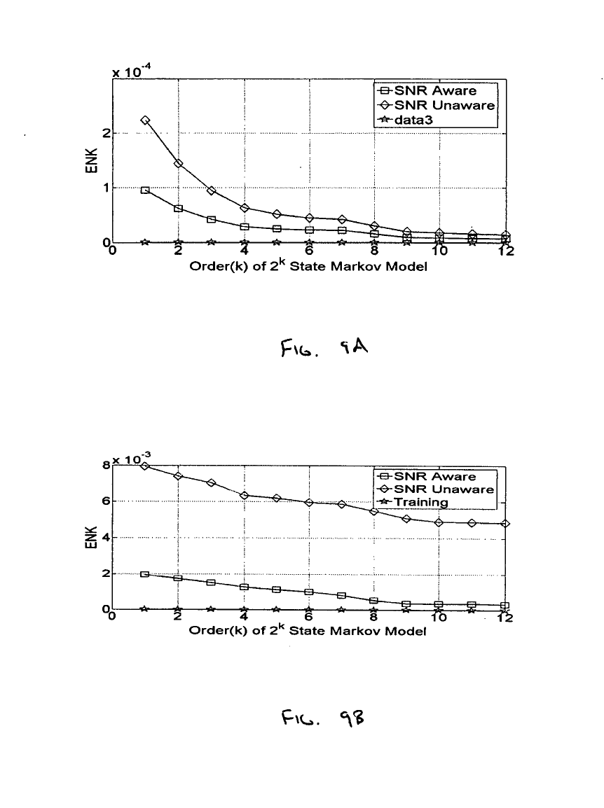

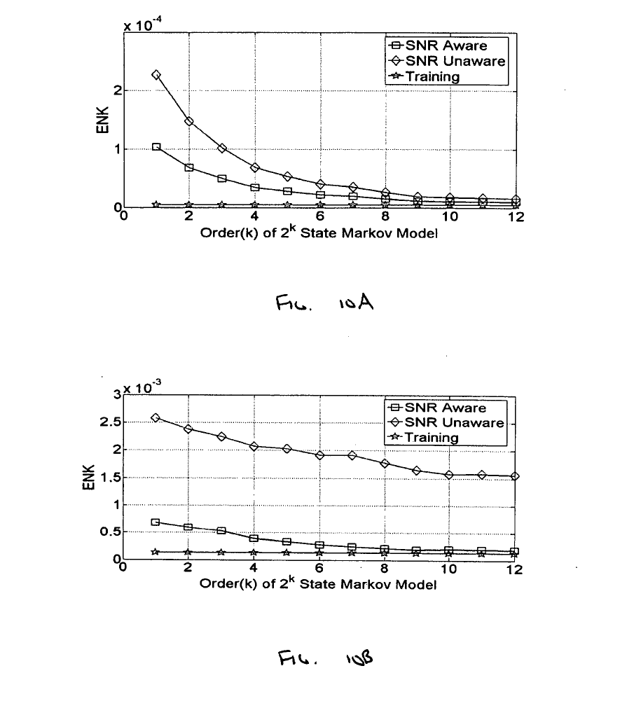

FIG. 9A shows the result of the above explained experiments. At low model order, the ability of an SSR aware model to capture the inter-arrival rate feature was significantly better than that that of an SSR unaware model. As the memory length increased, the relative entropy of the synthesized data for both the models was almost equal to that of the training data from the source. Hence to appropriately illustrate the utility of SSR_aware modeling (especially because the performance measure ENK is feature dependent) we consider the ability of the model to capture another feature, p. In many practical error control mechanisms, the distribution of p can play a pivotal role. Thus if a model is unable to extract this feature, simulations based on such a model may lead to conclusions that are not applicable over actual networks. It can be observed in FIG. 9B that an SSR aware scheme can provide performance close to that of the training data even by using low order Markov model. However, an SSR unaware Markov model provides drastically worse performance even for large memory lengths.

FIG. 9B show that an SSR aware scheme can provide performance close to that of the training data even by using low order Markov model. However, an SSR unaware Markov model provides drastically worse performance even for large memory lengths

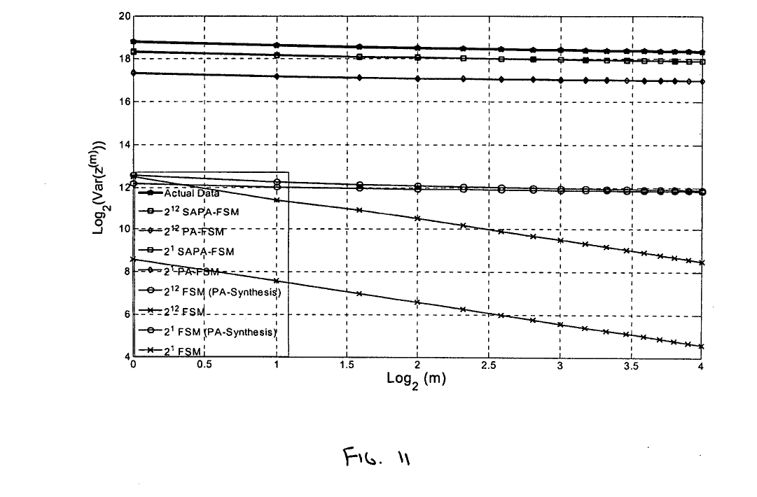

To further test the utility of an SSR aware modeling approach, we consider test data that was drawn from a completely different environment. For this purpose we consider the Office_data. The synthesized data was still generated on the basis of the transition matrix obtained by training on Home_data. FIG. 10 shows the performance in terms of ENK. It can be seen that the ENK between training data and test data is greater than before, thus underlining the significance of utilizing test data from a foreign environment. It can be observed that the SSR_aware model can characterize residue error traces from a distinct infrastructural setup also very well.

Till this point our analysis has been completely based on analyzing the residue error traces in a piece-wise manner. In the collected traces, corrupted packets do not necessarily occur continuously and similarly consecutive packets do not necessarily have identical SSR indications associated with them. Thus to test our belief that the work presented in the previous sections may be useful for development of future predictive tools in dynamic environments, in this section we consider the 802.11b residue error traces as a continuous process. We use various models to synthesize data.

For some models, the FCS and SSR traces associated with the actual residue error trace is provided as side-information. We evaluate the ability of the various models to replicate the features of the actual residue error traces. For the purpose of data synthesis, we consider:

(i) FSM model: This modeling approach is further described by Khayam et al in “S. A. Khayam and H. Radha, “Markov-based Modeling of Wireless Local Area Networks,” ACM MSWiM, September 2003. This approach is packet boundary unaware and SSR unaware, thus the model parameters are obtained by training the model on the entire residue error trace.

(ii) PA-FSM: This corresponds to a modeling scheme that is SSR_unaware but is packet boundary aware. Thus we leave the decision of whether a packet is uncorrupted or not to the frame check sequence. If the frame check sequence indicates that a packet is corrupted then the data in that location is synthesized on the basis of the SSR_unaware Markov model.

(iii) SAPA-FSM: This corresponds to a modeling scheme that is SSR_aware and packet boundary aware. Thus we leave the decision of whether a packet is uncorrupted or not to the frame check sequence. If the frame check sequence indicates that a packet is corrupted then the data in that location is synthesized on the basis of the SSR_aware Markov model. For the data synthesized using each of the above models, we calculated the log-variance plots (similar to FIG. 4 above).

FIG. 11 shows the result of such an experiment. The closer the log-variance plot of a synthetic data to the actual data, better would be the performance of a model as a predictive tool. Thus it can be observed that, even when a process is long-range dependent, very efficient prediction and channel characterization can be achieved if the channel state information provided by the frame check sequence and SSR indications is utilized in conjunction with an SSR_aware Markov Model. The significance of the results presented in FIG. 11 can be brought forth by highlighting its implications. Note, if a process is concluded to be long range dependent, then a long history may be essential to achieve good channel/process characterization. Results in FIG. 11 show that, in a practical system we could get efficient performance with zero history, as long as we do not ignore the channel state information.

One application for this work is for performing error recovery of corrupt data packets in a wireless communication system. Briefly, an indicator of bit errors is determined for each individual data packet received at a receiver. The bit error indicator for each data packet is then passed to an application layer of the receiver and an error recovery operation is performed in relation to a corrupt data packet using the bit indicator associated with the corrupt data packet. More specifically, the bit error indicator is translated to a probability that a given bit in the data packet is in error and this probability is in turn used to decode each bit within the corrupt data packet. Details regarding how the bit error indicator is captured and then used to perform an error recovery operation may be found in U.S. patent application Ser. No. ______ entitled “Method to Utilize Physical Layer Channel State Information to Improve Video Quality” which is filed concurrently herewith and incorporated herein by reference.

In this disclosure it has been shown that the ability of Markov models to characterize the residue errors in 802.11b can be greatly enhanced by making them SSR aware. The overall behavior of link-level residue errors is shown to be a function of the environment in which the wireless traces are collected. SSR indications can be useful in unbiasing the environmental and infrastructural biases. SSR_aware Markov models were shown to provide excellent performance in foreign environments also; and thus should prove useful for developing future error control, simulation/emulation applications.

Further areas of applicability will become apparent from the description provided herein. It should be understood that the description and specific examples are intended for purposes of illustration only and are not intended to limit the scope of the present disclosure.

What is claimed is:

1. A method for adapting models on the basis of link quality indicators, comprising:
defining a plurality of statistical models which predict whether a given data bit in a stream of data bits is in error, where each model includes an indicator of bit errors in the bit stream used to train the model;
receiving a data packet at a receiver in a wireless network;
determining an indicator of bit errors for the received data packet; and
processing the data packet at the receiver using a model from the plurality of models which correlates to the bit error indicator for the data packet.

2. The method of claim 1 further comprises defining the plurality of models as Markov models.

3. The method of claim 1 wherein the statistical model employs states which correlate to a pattern of data bits.

4. The method of claim 1 wherein the indicator of bit errors is reported by a communication protocol operating at a data link layer of the receiver.

5. The method of claim 1 wherein determining an indicator of bit errors further comprises receiving a signal to silence ratio for the data packet as reported in accordance with a 802.11b standard.

6. The method of claim 1 processing the data packet further comprises performing an error recovery operation in relation to the data packet.

7. A method for improving error recovery of corrupt data packets in a wireless communication system, comprising:
defining a statistical model that predicts whether a given data bit in a stream of data bits is in error;
capturing an indicator of bit errors for a given data packet received at a receiver;
adapting the statistical model using the bit error indicator; and
performing an error recovery operation in relation to the given data packet using the adapted statistical model.

8. The method of claim 7 wherein the statistical model is further defined as a Markov model.

9. The method of claim 7 wherein the statistical model employs states which correlate to a bit error pattern of data bits which precede the given data bit.

10. The method of claim 7 wherein capturing an indicator of bit errors occurs at a layer of the receiver below an application layer as defined by the Open System Interconnection (OSI) model.

11. The method of claim 7 wherein the indicator of bit errors is reported by a communication protocol operating at a data link layer of the receiver.

12. The method of claim 7 wherein capturing the indicator of the bit errors further comprises receiving a signal to silence ratio for the data packet as reported in accordance with a 802.11b standard.

13. The method of claim 7 wherein performing an error recovery operation further comprises decoding each bit in the given data packet using an output of the adapted statistical model.

14. The method of claim 7 further comprises:
capturing an indicator of bit errors for a subsequently received data packet;
adapting the statistical model using the bit error indicator for the subsequently received data packet; and
performing an error recovery operation in relation to the subsequently received data packet using the adapted statistical model.

15. A method for synthesizing bit streams which correlate to different transmission environments, comprising:
defining a plurality of statistical models which predict whether a given data bit in a stream of data bits is in error, where each model includes an indicator of bit errors in the bit stream used to train the model;
determining an indicator of bit errors for a desired transmission environment;
selecting one of the plurality of statistical models based on the determined bit error indicator; and
generating a bit stream using the selected model.

16. The method of claim 15 wherein the statistical models are further defined as Markov models.

17. The method of claim 15 wherein the statistical models employ states which correlate to a bit error pattern of data bits which precede a given data bit.

18. The method of claim 15 wherein defining a plurality of statistical models further comprises training the statistical models using bit streams transmitted in different environments and associating with each of the trained models an indicator of the bit errors which occur in the bit stream used to train a given model.

19. The method of claim 15 wherein the indicator of bit errors is further defined as a signal to silence ratio.
